(19) United States
(12) Patent Application Publication
(10) Pub. No.: US 2024/0359170 A1
(43) Pub. Date: Oct. 31, 2024

(54) Methane-Reforming Catalyst and Method for Producing Same

(71) Applicant: LG Chem, Ltd., Seoul (KR)

(72) Inventors: Jun Yeon Cho, Daejeon (KR); Sojin Kim, Daejeon (KR); Suji Kim, Daejeon (KR); Jun Seon Choi, Daejeon (KR); Sangjin Kim, Daejeon (KR); Jae Soon Choi, Daejeon (KR)

(73) Assignee: LG Chem, Ltd., Seoul (KR)

(21) Appl. No.: 18/274,105

(22) PCT Filed: Aug. 1, 2022
(86) PCT No.: PCT/KR2022/011327

§ 371 Date: Jul. 25, 2023

(30) Foreign Application Priority Data
Nov. 18, 2021 (KR) 10-2021-0159456

(51) Int. Cl. B01J 35/00; B01J 23/00; B01J 23/02; B01J 23/58; B01J 23/78; B01J 23/83; B01J 23/86; B01J 35/64; B01J 35/70; B01J 37/02; B01J 37/08; B01J 37/18; C01B 3/40

(52) U.S. Cl. CPC B01J 35/19; B01J 23/002; B01J 23/02; B01J 23/58; B01J 23/78; B01J 23/83; B01J 23/866; B01J 35/657; B01J 35/733; B01J 37/0225; B01J 37/0236; B01J 37/0244; B01J 37/088; B01J 37/18; C01B 3/40; B01J 2523/24; B01J 2523/36; B01J 2523/47; B01J 2523/821; B01J 2523/847; C01B 2203/0238; C01B 2203/1058; C01B 2203/1064; C01B 2203/1082; C01B 2203/1241

(57) ABSTRACT

The catalyst for methane reformation according to an exemplary embodiment of the present application comprises: a porous metal support; a first coating layer provided on the porous metal support and comprising the perovskite-based compound represented by Chemical Formula 1; and a second coating layer provided on the first coating layer and comprising the perovskite-based compound represented by Chemical Formula 2:

SrTiO₃ [Chemical Formula 1]

Sr₁₋ₓAₓTi_{α}B_{y}O_{3-δ} [Chemical Formula 2]
wherein all the variables are described herein.

### CROSS-CITATION WITH RELATED APPLICATIONS

This application is a national stage entry under 35 U.S.C. § 371 of International Application No. PCT/KR2022/011327 filed on Aug. 1, 2022, which claims priority from Korean Patent Application No. 10-2021-0159456 filed on Nov. 18, 2021, all the disclosures of which are incorporated herein by reference.

### TECHNICAL FIELD

The present application relates to a catalyst for methane reformation and a method for producing the same.

### BACKGROUND ART

As part of activities to reduce greenhouse gases caused by global warming, many studies on carbon dioxide conversion technologies have been conducted. The carbon dioxide reforming reaction, one of the carbon dioxide conversion technologies, is a technology to obtain synthesis gas composed of hydrogen and carbon monoxide by reacting methane and carbon dioxide.

Synthesis gas is a material with high development value from diverse downstream raw materials. As a method for industrially obtaining synthesis gas (H₂/CO), the reforming reaction of natural gas may be largely divided into a steam reforming process, a carbon dioxide (CO₂) reforming process, a catalytic partial oxidation process, an autothermal reforming process, a tri-reforming process, such as the following Reaction Schemes 1 to 5, and the like.

$${CH}_{4} + {H}_{2} O \to 3 {H}_{2} + CO Δ H = 226 kJ / mol \qquad [ Reaction Scheme 1 ]$$

$${CH}_{4} + {CO}_{2} \to 2 {H}_{2} + 2 CO Δ H = 261 kJ / mol \qquad [ Reaction Scheme 2 ]$$

$${CH}_{4} + 0.5 {O}_{2} \to 2 {H}_{2} + CO Δ H = - 44 kJ / mol \qquad [ Reaction Scheme 3 ]$$

$$autothermal reforming : Reaction Scheme 1 + Reaction Scheme 3 \qquad [ Reaction Scheme 4 ]$$

$$tri - reforming : Reaction Scheme 1 + Reaction Scheme 2 + Reaction Scheme 3 \qquad [ Reaction Scheme 5 ]$$

Meanwhile, various catalysts may be used for reforming activity in the reforming process. Among them, when noble metal catalysts are used in the reforming process, there is an advantage in that the efficiency of converting natural gas into hydrogen is high, but there is a problem in that the economic feasibility deteriorates because noble metal catalysts are expensive.

Accordingly, nickel catalysts, which have a high hydrogen conversion efficiency and are relatively inexpensive, are usually used in the reforming process. However, in such a case, there is a problem in that the nickel catalyst is deactivated by carbon that is inevitably produced on the surface of the nickel catalyst.

Therefore, there is a need in the art for developing a catalyst which is resistant to carbon deposition and can be effectively applied to the reforming process of methane.

### DETAILED DESCRIPTION OF THE INVENTION

### Technical Problem

The present application has been made in an effort to provide a catalyst for methane reformation and a method for producing the same.

### Technical Solution

An exemplary embodiment of the present application provides a catalyst for methane reformation, comprising:
a porous metal support;
a first coating layer provided on the porous metal support and comprising a perovskite-based compound represented by the following Chemical Formula 1; and
a second coating layer provided on the first coating layer and comprising a perovskite-based compound represented by the following Chemical Formula 2.

SrTiO₃ [Chemical Formula 1]

Sr₁₋ₓAₓTi_{α}B_{y}O_{3-δ} [Chemical Formula 2]
In Chemical Formula 2,
A is selected from Y, Sc, La or lanthanide series elements,
B is Ni, Co, Fe, Mn, Cr, Mo, Ru or Rh,
x is a real number of 0 or more and less than 1,
y is a real number of 0 or more and less than 0.3,
δ is a real number of 0 or more and less than 1,
α is a real number of more than 0.7 and 1 or less, and
(x+y)>0 is satisfied.

Further, another exemplary embodiment of the present application provides a method for producing a catalyst for methane reformation, the method comprising:
preparing each of a first solution comprising a precursor of the perovskite-based compound represented by Chemical Formula 1; and a second solution comprising a precursor of the perovskite-based compound represented by Chemical Formula 2;
producing a catalyst precursor provided with a first coating layer by coating a porous metal support with the first solution, and then performing a first heat treatment process; and
producing a catalyst provided with a second coating layer by coating the catalyst precursor provided with the first coating layer with the second solution, and then performing a second heat treatment process.

### Advantageous Effects

The catalyst for methane reformation according to an exemplary embodiment of the present application can not only improve adhesion between a porous metal support and a second coating layer comprising a perovskite-based compound represented by Chemical Formula 2, but can also prevent side reactions of the porous metal support by forming a first coating layer comprising the catalyst component-free perovskite-based compound represented by Chemical Formula 1.

Furthermore, the catalyst for methane reformation according to an exemplary embodiment of the present application is characterized in that reaction heat is easily controlled compared to pellet-type or powder-type catalysts in the related art because a perovskite-based compound is supported on a porous metal support having high thermal conductivity.

In addition, the catalyst for methane reformation according to an exemplary embodiment of the present application can exhibit high activity even at a high space velocity during a reforming reaction of methane because it is possible to increase the active surface area of the catalyst.

### BRIEF DESCRIPTION OF THE DRAWINGS

FIG. 1A and FIG. 1B are views illustrating a set of electron microscope photographs of the surface of the catalyst for methane reformation according to Example 1 of the present application.

### BEST MODE

Hereinafter, the present specification will be described in more detail.

When one member is disposed “on” another member in the present specification, this comprises not only a case where the one member is brought into contact with another member, but also a case where still another member is present between the two members.

When one part “comprises” one constituent element in the present specification, unless otherwise specifically described, this does not mean that another constituent element is excluded, but means that another constituent element may be further comprised.

Currently, in the case of catalysts which are widely used in the field of reformers, generally, powder-type catalysts and pellet-type support catalysts are usually used. Although the powder-type catalysts may have excellent performance due to excellent dispersion degree of the catalyst, it is difficult to directly use the powder-type catalyst in the industry. For example, when a reformer is driven using the powder-type catalyst, the catalyst comes out together with a material produced after the reaction, and in this case, the catalyst in the form of a powder gradually accumulates in the stream tube at the exit portion, and eventually, a phenomenon of blocking the entire tube may occur. Therefore, there is a disadvantage in that the powder-type catalysts cannot be used in the commercial reformers used in the industry.

In addition, the pellet-type support catalyst is currently frequently used in industrial reformers. Due to the limitation of the mass transfer rate, the performance deteriorates compared to the powder-type catalyst only in terms of the catalyst performance, but there is an advantage in that the pellet-type support catalyst can be used for a long period of time because a support is used. However, a γ-Al₂O₃ pellet, which is often used as the pellet-type support catalyst, has a weak structural strength, and thus may be easily broken, and accordingly, there is a disadvantage in that a differential pressure in the reactor is generated. Furthermore, since the volume is large due to the characteristics of the pellet-type support catalyst, the volume thereof becomes considerably large when the pellet-type support catalyst is used in a high-capacity reformer. Further, all reforming reactions are sensitive to reaction temperature, but the existing pellet-type catalyst has a disadvantage in that heat is not evenly distributed throughout the reactor due to a large reduction in thermal conductivity. In addition, since the reforming reaction is very fast, in the case of a pellet-type support or an extruded catalyst, the effectiveness factor of the catalyst is 0.3 or less, so that there is a disadvantage in that the utilization of the catalyst deteriorates.

Thus, the present application intended to alleviate a phenomenon of blocking the stream tube, which is a disadvantage of the powder-type, and improve the heat and mass transfer rates which are a common disadvantage of the powder-type and the pellet-type, through a method of coating a porous metal support catalyst having high heat and mass transfer rates with a catalyst. Further, the present application intends to provide a catalyst for methane reformation capable of supporting a large amount of catalyst at one time and suppressing side reactions caused by a binder.

The catalyst for methane reformation according to an exemplary embodiment of the present application comprises: a porous metal support; a first coating layer provided on the porous metal support and comprising the perovskite-based compound represented by Chemical Formula 1; and a second coating layer provided on the first coating layer and comprising the perovskite-based compound represented by Chemical Formula 2.

In an exemplary embodiment of the present application, the perovskite-based compound represented by Chemical Formula 1 is a catalyst component-free compound, the perovskite-based compound represented by Chemical Formula 2 is a compound comprising a catalyst component (A and/or B of Chemical Formula 2), and these are different from each other.

In an exemplary embodiment of the present application, Chemical Formula 2 may be represented by the following Chemical Formula 3 or 4.

SrTi_{α}B_{y}O_{3-δ} [Chemical Formula 3]

Sr₁₋ₓYₓTi_{α}B_{y}O_{3-δ} [Chemical Formula 4]
In Chemical Formulae 3 and 4,
B is Ni or Ru,
x is a real number of more than 0 and less than 1,
y is a real number of more than 0 and less than 0.3, and
δ is a real number of more than 0 and less than 1, and
α is a real number of more than 0.7 and 1 or less.

In an exemplary embodiment of the present application, the porous metal support may be composed of a material capable of maintaining thermal stability at a high temperature of 800° C. or more.

In an exemplary embodiment of the present application, the porous metal support may be a metal foam comprising NiFeCrAl, NiCrAl, SiC or α-Al₂O₃.

The porous metal support is a support having various shapes, has a small heat capacity and an excellent heat transfer ability, and thus may be molded into a desired shape for use. The form, size and the like of the porous metal support are not particularly limited, and the porous metal support may have a porosity of 10% to 99%, 50% to 96%, and 85% to 96%. The porous metal support may have an average pore size (cell size) of 400 μm to 2,000 μm, and 450 μm to 1,500 μm. When the porous metal support has an average pore size of less than 400 μm, it may be difficult to coat the porous metal support with a precursor solution, and when the porous metal support has an average pore size of more than 2,000 μm, the surface area on which the catalyst can be coated is reduced, so that the average pore size range is not preferred because the range may be disadvantageous in the process. The porous metal support may be appropriately produced by those skilled in the art using methods known in the art, in consideration of the material, pore size, porosity, and the like of the porous metal support. According to an exemplary embodiment of the present application, a porous metal support having various materials, pore sizes, and the like may be applied as in Examples to be described below.

In an exemplary embodiment of the present application, a content of the perovskite-based compound represented by Chemical Formula 1 may be 1 wt % to 20 wt %, and 1.5 wt % to 18 wt % based on the total weight of the porous metal support. When the content of the perovskite-based compound represented by Chemical Formula 1 exceeds 20 wt %, the remaining capacity capable of coating the perovskite-based compound represented by Chemical Formula 2 may be reduced, and accordingly, the aforementioned weight range is not preferred because the activity of the catalyst may be reduced compared to the volume of the porous metal support. Furthermore, when the content of the perovskite-based compound represented by Chemical Formula 1 is less than 1 wt %, it may be difficult to obtain the effect caused by the first coating layer because the content is so small.

In an exemplary embodiment of the present application, the weight ratio of the perovskite-based compound represented by Chemical Formula 1: the perovskite-based compound represented by Chemical Formula 2 may be 1:1 to 1:20, and 1:1.1 to 1:15. The case where the weight ratio of the perovskite-based compound represented by Chemical Formula 1: the perovskite-based compound represented by Chemical Formula 2 is out of the range is not preferred because the activity of the catalyst may be reduced compared to the volume of the porous metal support.

In an exemplary embodiment of the present application, the (a+y) of Chemical Formula 2 may be 1. Further, in an exemplary embodiment of the present application, the (a+y) of Chemical Formula may be a real number of more than 0.90 and less than 1. In Chemical Formula 2, B such as Ni substitutes a part of Ti, and the theoretical stoichiometric ratio of (α+y) is 1, but when the content of Ti is slightly less than the theoretical stoichiometric ratio during the preparation of the perovskite-based compound represented by Chemical Formula 2, Ti in Chemical Formula 2 may be more easily substituted with B such as Ni.

In an exemplary embodiment of the present application, a content of the perovskite-based compound represented by Chemical Formula 2 may be 3 wt % to 40 wt %, 6 wt % to 35 wt %, and 7 wt % to 30 wt %, based on a total weight of the catalyst for methane reformation. When the content of the perovskite-based compound represented by Chemical Formula 2 is less than 3 wt % based on the total weight of the catalyst for methane reformation, the reactivity may be lowered due to relatively few active sites on the catalyst surface, so the content is not preferred. In addition, when the content of the perovskite-based compound represented by Chemical Formula 2 exceeds 40 wt %, a relatively large amount of the catalyst component is contained compared to the porous metal support, making it difficult to maintain the pore structure, it may not be easy to bond the catalyst component to the porous metal support, and accordingly, the practical benefits of the methane reforming reaction may be reduced.

In an exemplary embodiment of the present application, the first coating layer may be provided on the entire surface on the porous metal support.

In an exemplary embodiment of the present application, at least a portion of the surface of the catalyst for methane reformation may comprise protrusion shapes. The protrusion shape may be spherical, elliptical, or a combination thereof, but is not limited thereto.

In an exemplary embodiment of the present application, the first coating layer comprising the perovskite-based compound represented by Chemical Formula 1 may serve to fix the second coating layer comprising the perovskite-based compound represented by Chemical Formula 2 on the porous metal support. Furthermore, the second coating layer comprising the perovskite-based binder compound represented by Chemical Formula 2 may be present in the form of protrusions on the first coating layer, and accordingly, the performance of the methane reforming reaction may be improved by increasing the reaction surface area of the catalyst.

Further, according to an exemplary embodiment of the present application, by simultaneously applying the first coating layer comprising the perovskite-based compound represented by Chemical Formula 1; and the second coating layer comprising the perovskite-based compound represented by Chemical Formula 2, the total content of catalyst supported on the porous metal support may be increased compared to when catalyst particles are applied alone. In addition, according to an exemplary embodiment of the present application, the durability and performance of the catalyst may be improved because it is possible to prevent a phenomenon in which a metal (Ni, Cr, and the like) that is the main component of the porous metal support is exposed to the surface in the form of a metal oxide (NiO, Cr₂O₃, and the like) under long-term operation conditions at high temperature (750° C. or higher) and prevent the changes in component proportion or phase of the catalyst of Chemical Formula 2 by applying the first coating layer comprising the perovskite-based compound represented by Chemical Formula 1.

In an exemplary embodiment of the present application, the catalyst for methane reformation may be applied to a steam reforming process, a carbon dioxide (CO₂) reforming process, a catalytic partial oxidation process, an autothermal reforming process, a tri-reforming process or a mixed reforming process, and the methane reforming process is not particularly limited.

The method for producing a catalyst for methane reformation according to an exemplary embodiment of the present application comprises: preparing each of a first solution comprising a precursor of the perovskite-based compound represented by Chemical Formula 1; and a second solution comprising a precursor of the perovskite-based compound represented by Chemical Formula 2; producing a catalyst precursor provided with a first coating layer by coating a porous metal support with the first solution, and then performing a first heat treatment process; and producing a catalyst provided with a second coating layer by coating the catalyst precursor provided with the first coating layer with the second solution, and then performing a second heat treatment process.

In the method for producing a catalyst for methane reformation according to an exemplary embodiment of the present application, details on the porous metal support, the perovskite-based compound represented by Chemical Formula 1, the perovskite-based compound represented by Chemical Formula 2, and the like are the same as those as described above.

In particular, the first solution comprising the precursor of the perovskite-based compound represented by Chemical Formula 1 and the second solution comprising the precursor of the perovskite-based compound represented by Chemical Formula 2 may be each applied in the form of a sol or gel.

The precursor of the perovskite-based compound is a precursor of the metal constituting the perovskite-based compound, and the metal molar ratio of the perovskite-based compound may be adjusted by adjusting the content thereof. In addition, the precursor of the metal is not particularly limited, and ammonium salts, nitrates, carbonates, chlorides, lactates, hydroxides, organic acid salts, oxides of the metal elements, or mixtures thereof may be applied in combination.

The method for producing a catalyst for methane reformation according to an exemplary embodiment of the present application comprises preparing each of a first solution comprising a precursor of the perovskite-based compound represented by Chemical Formula 1; and a second solution comprising a precursor of the perovskite-based compound represented by Chemical Formula 2.

The first solution and the second solution may each independently further comprise a solvent, and as the solvent, a solvent known in the art may be applied, and is not particularly limited thereto.

The method for producing a catalyst for methane reformation according to an exemplary embodiment of the present application comprises: producing a catalyst precursor provided with a first coating layer by coating a porous metal support with the first solution, and then performing a first heat treatment process; and producing a catalyst provided with a second coating layer by coating the catalyst precursor provided with the first coating layer with the second solution, and then performing a second heat treatment process.

As the coating method of the first solution and the second solution, methods known in the art may be used, and dip-coating, wash-coating and the like may be used, but the method is not limited thereto.

The first heat treatment process and the second heat treatment process may each independently comprise performing drying and firing. The drying may be performed at a temperature of 50° C. to 150° C. for 1 hour to 48 hours, and may be performed at a temperature of 60° C. to 100° C. for 5 hours to 36 hours, but is not limited thereto. Further, the firing may be performed at a temperature of 350° C. to 1100° C. for 1 hour to 10 hours in an air atmosphere, and may be performed at a temperature of 500° C. to 1,000° C. for 1.5 hours to 8 hours in an air atmosphere, but is not limited thereto. When the firing is performed at a temperature less than 350° C., the perovskite phase may not be properly formed, and when the firing is performed at a temperature more than 1,100° C., the durability of the porous metal support may deteriorate, so that the temperature is not preferred.

In an exemplary embodiment of the present application, the method may further comprise measuring the weight of the catalyst supported on the porous metal support after the second heat treatment process. In addition, by measuring the weight of the catalyst supported on the porous metal support, the coating of the catalyst precursor provided with the first coating layer with the above-described second solution, and then the performing of the second heat treatment process may be performed repeatedly once to 10 times until a desired amount of catalyst is supported on the porous metal support.

The catalyst for methane reformation according to an exemplary embodiment of the present application can not only improve adhesion between a porous metal support and a second coating layer comprising a perovskite-based compound represented by Chemical Formula 2, but can also prevent side reactions of the porous metal support by forming a first coating layer comprising the catalyst component-free perovskite-based compound represented by the following Chemical Formula 1.

Furthermore, the catalyst for methane reformation according to an exemplary embodiment of the present application is characterized in that reaction heat is easily controlled compared to pellet-type or powder-type catalysts in the related art because a perovskite-based compound is supported on a porous metal support having high thermal conductivity.

In addition, the catalyst for methane reformation according to an exemplary embodiment of the present application can exhibit high activity even at a high space velocity during a reforming reaction of methane because it is possible to increase the active surface area of the catalyst.

### MODE FOR INVENTION

Hereinafter, the present application will be described in detail with reference to Examples for specifically describing the present application. However, the Examples according to the present application may be modified in various forms, and it is not interpreted that the scope of the present application is limited to the Examples described in detail below. The Examples of the present application are provided for more completely explaining the present application to the person with ordinary skill in the art.

### EXAMPLES

### Example 1

### 1) Preparation of First Solution Comprising Precursor of Perovskite-Based Compound (SrTiO₃)

A perovskite compound component solution was prepared by the citrate method. Strontium nitrate (Sr(NO₃)₃H₂O) was dissolved in distilled water together with citric acid and ethylene glycol. After titanium isopropoxide (Ti(OCH(CH₃)₂)₄) was dissolved in ethanol, the two solutions were mixed at 70° C. Thereafter, after the mixture was stirred for 3 hours, the mixture was cooled to room temperature and stored. In this case, the concentration of the solution was 0.1 M.

2) Preparation of Second Solution Comprising Precursor of Perovskite-Based Compound (SrTi_{0.97}Ni_{0.03}O_{3-δ}, 0<δ<1) Represented by Chemical Formula 2

A process was performed in the same manner as in 1) above, except that nickel nitrate (Ni(NO₃)₂) was added and used in an amount of 3 mol % relative to titanium based on the metal.

### 3) Production of Catalyst for Methane Reformation

A porous metal support (NiCrAl, average pore size: 1,200 μm) was dip-coated with the first solution (formation of a first coating layer), and then dried at 70° C. for 24 hours, and heat-treated at 300° C. to 900° C. in an air atmosphere for 3 hours.

Thereafter, the porous metal support in which the first coating layer was formed was dip-coated with the second solution (formation of a second coating layer), and then dried at 70° C. for 24 hours, and heat-treated at 300° C. to 900° C. in an air atmosphere for 3 hours. The dip coating, drying and heat treatment of the second solution was repeated several times to finally produce a catalyst in which a first coating layer (SrTiO₃) and a second coating layer (SrTi_{0.97}Ni_{0.03}O_{3-δ}, 0<δ<1) were provided on a porous metal support. Based on the total weight of the catalyst for methane reformation, the content of the perovskite-based compound (SrTiO₃) was 7 wt %, and the content of the perovskite-based compound (SrTi_{0.97}Ni_{0.03}O_{3-δ}, 0<δ<1) represented by Chemical Formula 2 was 20 wt %.

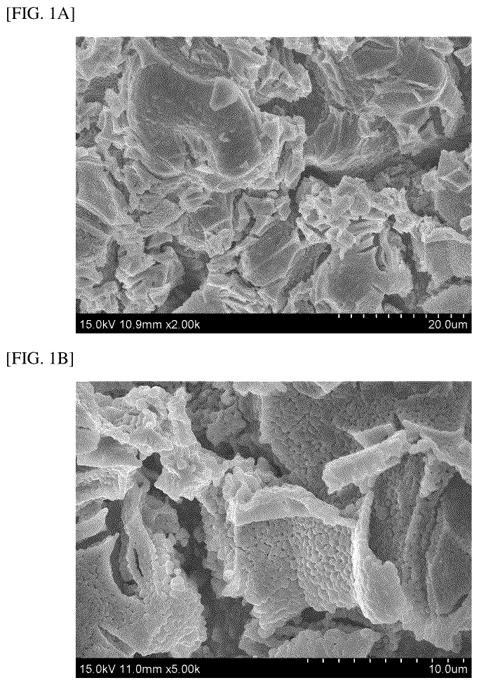

A set of electron microscope photographs of the surface of the catalyst for methane reformation according to Example 1 of the present application is illustrated in the following FIG. 1A and FIG. 1B.

The content of the perovskite-based compound represented by Chemical Formula 1 or 2 may be calculated by the following Equation 1.

Content (wt %) of perovskite-based compound represented by Chemical Formula 1 or 2=(total weight of catalyst−weight of porous metal support)/(total weight of catalyst)×100 [Equation 1]

### Example 2

A process was performed in the same manner as in Example 1, except that yttrium nitrate (Y(NO₃)₂) was added in an amount of 12 mol % relative to strontium based on the metal during the preparation of the second solution and nickel nitrate (Ni(NO₃)₂) was added such that the molar ratio of titanium:nickel became 0.80:0.15.

### Example 3

A process was performed in the same manner as in Example 1, except that yttrium nitrate (Y(NO₃)₂) was added in an amount of 12 mol % relative to strontium based on the metal during the preparation of the second solution and nickel nitrate (Ni(NO₃)₂) was added such that the molar ratio of titanium:nickel became 0.80:0.20.

### Example 4

A process was performed in the same manner as in Example 1, except that ruthenium chloride (RuCl₃) was added and used in an amount of 5 mol % relative to titanium based on the metal instead of nickel nitrate (Ni(NO₃)₂) during the preparation of the second solution.

### Example 5

A process was performed in the same manner as in Example 1, except that yttrium nitrate (Y(NO₃)₂) was added in an amount of 8 mol % relative to strontium based on the metal during the preparation of the second solution and ruthenium chloride (RuCl₃) was added such that the molar ratio of titanium:ruthenium became 0.80:0.15.

### Example 6

A process was performed in the same manner as in Example 3, except that the content of the perovskite-based compound (SrTiO₃) was adjusted so as to be 1.7 wt % based on the total weight of the catalyst for methane reformation.

### Example 7

A process was performed in the same manner as in Example 3, except that the content of the perovskite-based compound (SrTiO₃) was adjusted so as to be 13 wt % based on the total weight of the catalyst for methane reformation.

### Example 8

A process was performed in the same manner as in Example 3, except that the content of the perovskite-based compound (SrTiO₃) was adjusted so as to be 17 wt % based on the total weight of the catalyst for methane reformation.

### Example 9

A process was performed in the same manner as in Example 3, except that as the porous metal support, NiFeCrAl (average pore size: 1,200 μm) was applied instead of NiCrAl.

### Example 10

A process was performed in the same manner as in Example 3, except that as the porous metal support, NiCrAl_800 (average pore size: 800 μm) was applied instead of NiCrAl.

### Example 11

A process was performed in the same manner as in Example 3, except that as the porous metal support, NiCrAl_1500 (average pore size: 1,500 μm) was applied instead of NiCrAl.

### Comparative Example 1

A porous metal support (NiCrAl, average pore size: 1,200 μm) alone was used as Comparative Example 1.

### Comparative Example 2

A process was performed in the same manner as in Example 1, except that the coating of the porous metal support with the first solution alone was applied without the coating of the catalyst precursor with the second solution.

### Comparative Example 3

A process was performed in the same manner as in Example 1, except that the coating of the catalyst precursor with the second solution alone was applied without the coating of the porous metal support with the first solution.

### Comparative Example 4

A process was performed in the same manner as in Example 3, except that the coating of the catalyst precursor with the second solution alone was applied without the coating of the porous metal support with the first solution.

The configurations of the porous metal supports, the first coating layer and the second coating layer in the Examples and Comparative Examples are shown in the following Table 1.

TABLE 1

| | Porous metal | First coating | Second coating |
|---|---|---|---|
| | support | layer | layer |
| Example 1 | NiCrAl | SrTiO₃ | SrTi_{0.97}Ni_{0.03}O_{3-δ} |
| Example 2 | NiCrAl | SrTiO₃ | Sr_{0.88}Y_{0.12}Ti_{0.80}Ni_{0.15}O_{3-δ} |
| Example 3 | NiCrAl | SrTiO₃ | Sr_{0.88}Y_{0.12}Ti_{0.80}Ni_{0.20}O_{3-δ} |
| Example 4 | NiCrAl | SrTiO₃ | SrTi_{0.95}Ru_{0.05}O_{3-δ} |
| Example 5 | NiCrAl | SrTiO₃ | Sr_{0.92}Y_{0.08}Ti_{0.80}Ru_{0.15}O_{3-δ} |
| Example 6 | NiCrAl | SrTiO₃ | Sr_{0.88}Y_{0.12}Ti_{0.80}Ni_{0.20}O_{3-δ} |
| Example 7 | NiCrAl | SrTiO₃ | Sr_{0.88}Y_{0.12}Ti_{0.80}Ni_{0.20}O_{3-δ} |
| Example 8 | NiCrAl | SrTiO₃ | Sr_{0.88}Y_{0.12}Ti_{0.80}Ni_{0.20}O_{3-δ} |
| Example 9 | NiFeCrAl | SrTiO₃ | Sr_{0.88}Y_{0.12}Ti_{0.80}Ni_{0.20}O_{3-δ} |
| Example 10 | NiCrAl_800 | SrTiO₃ | Sr_{0.88}Y_{0.12}Ti_{0.80}Ni_{0.20}O_{3-δ} |
| Example 11 | NiCrAl_1500 | SrTiO₃ | Sr_{0.88}Y_{0.12}Ti_{0.80}Ni_{0.20}O_{3-δ} |
| Comparative | NiCrAl | — | — |
| Example 1 | | | |
| Comparative | NiCrAl | SrTiO₃ | — |
| Example 2 | | | |
| Comparative | NiCrAl | — | SrTi_{0.97}Ni_{0.03}O_{3-δ} |
| Example 3 | | | |
| Comparative | NiCrAl | — | Sr_{0.88}Y_{0.12}Ti_{0.80}Ni_{0.20}O_{3-δ} |
| Example 4 | | | |

### <Experimental Example 1> Evaluation of Dry Reforming Reaction of Methane

A fixed-bed reactor system was introduced to carry out a dry reforming reaction of methane. A Quartz tube reactor (inner diameter=½ inch, length=50 cm) was used and packed with each catalyst (about 2 g) of the Examples and the Comparative Examples. First, after the catalyst underwent a reduction process at 800° C. under 10% H₂/N₂ conditions for 1 hour to 2 hours, a catalytic reaction was performed for 100 hours. In order to more clearly compare the difference in activity between the catalysts, the activity characteristics of the catalysts were evaluated at severe space velocities.
Gas composition: CH₄:CO₂:N₂=1:1.2:0.96
Flow rate: gas hour space velocity (GHSV)=2,500 hr⁻¹ (based on CH₄)
Reaction temperature: 750° C.
Reaction pressure: 1 bar

A reaction conversion rate after 100 hours of reaction was calculated by analyzing the composition of the produced gas using gas chromatography (GC), and is shown in the following Table 2.

$$Conversion rate ( Xi , \% ) = [ ( {Fi}_{in} - {Fi}_{out} ) / {Fi}_{in} ] \times 100 ( Fi = flow rate of i )$$

### <GC Analysis Conditions>

1) GC model: Agilent 6890
2) Oven temp.: 40° C./7 min-90° C./5 min-180° C./6 min
3) Detector: TCD, 250° C.
4) Sample: 0.25 mL
5) Valve box Temp.: 150° C.

TABLE 2

| | | CH₄ | CO₂ | |
|---|---|---|---|---|
| | | conversion | conversion | |
| Catalyst type | GHSV(hr⁻¹) | rate (%) | rate (%) | H₂/CO |
| Example 1 | 2,500 | 44 | 52 | 0.76 |
| Example 2 | 2,500 | 58 | 65 | 0.76 |
| Example 3 | 2,500 | 60 | 69 | 0.76 |
| Example 4 | 2,500 | 61 | 65 | 0.78 |
| Example 5 | 2,500 | 61 | 64 | 0.78 |
| Example 6 | 2,500 | 57 | 62 | 0.75 |
| Example 7 | 2,500 | 62 | 70 | 0.78 |
| Example 8 | 2,500 | 58 | 64 | 0.75 |
| Comparative | 2,500 | 18 | 20 | 0.54 |
| Example 1 | | | | |
| Comparative | 2,500 | 3 | 4 | 0.20 |
| Example 2 | | | | |
| Comparative | 2,500 | 42 | 50 | 0.73 |
| Example 3 | | | | |
| Comparative | 2,500 | 50 | 58 | 0.72 |
| Example 4 | | | | |

As in the results of Table 2, it can be confirmed that when Example 1 and Comparative Example 3 are compared to each other or Example 3 and Comparative Example 4 are compared to each other, the catalyst for methane reformation according to the present invention, which comprises the porous metal support, the first coating layer comprising the perovskite-based compound represented by Chemical Formula 1, and the second coating layer comprising the perovskite-based compound represented by Chemical Formula 2 has excellent CH₄ conversion rate and CO₂ conversion rate, compared to Comparative Examples 3 and 4 to which the first coating layer is not applied.

### <Experimental Example 2> Evaluation of Dry Reforming Reaction of Methane

A fixed-bed reactor system was introduced to carry out a dry reforming reaction of methane. A Quartz tube reactor (inner diameter=½ inch, length=50 cm) was used and packed with each catalyst (about 2 g) of the Examples and the Comparative Examples. First, after the catalyst underwent a reduction process at 800° C. under 10% H₂/N₂ conditions for 1 hour to 2 hours, a catalytic reaction was performed for 100 hours. In order to more clearly compare the difference in activity between the catalysts, the activity characteristics of the catalysts were evaluated at severe space velocities.
Gas composition: CH₄:CO₂:N₂=1:1.2:0.96
Flow rate: gas hour space velocity (GHSV)=1,500 hr⁻¹ (based on CH₄)
Reaction temperature: 800° C.
Reaction pressure: 1 bar

A reaction conversion rate after 100 hours of reaction was calculated by analyzing the composition of the produced gas using gas chromatography (GC), and is shown in the following Table 3.

$$Conversion rate ( Xi , \% ) = [ ( {Fi}_{in} - {Fi}_{out} ) / {Fi}_{in} ] \times 100 ( Fi = flow rate of i )$$

### <GC Analysis Conditions>

1) GC model: Agilent 6890
2) Oven temp.: 40° C./7 min-90° C./5 min-180° C./6 min
3) Detector: TCD, 250° C.
4) Sample: 0.25 mL
5) Valve box Temp.: 150° C.

TABLE 3

| | | CH₄ | CO₂ | |
|---|---|---|---|---|
| | | conversion | conversion | |
| Catalyst type | GHSV(hr⁻¹) | rate (%) | rate (%) | H₂/CO |
| Example 3 | 1,500 | 91 | 89 | 0.84 |
| Example 5 | 1,500 | 91 | 90 | 0.85 |
| Example 9 | 1,500 | 90 | 88 | 0.84 |
| Example 10 | 1,500 | 92 | 91 | 0.85 |
| Example 11 | 1,500 | 88 | 87 | 0.84 |
| Comparative | 1,500 | 89 | 88 | 0.82 |
| Example 4 | | | | |

As in the results of Table 3, it can be confirmed that when Example 3 and Comparative Example 4 are compared to each other, the catalyst for methane reformation according to the present invention, which comprises the porous metal support, a first coating layer comprising the perovskite-based compound represented by Chemical Formula 1, and a second coating layer comprising the perovskite-based compound represented by Chemical Formula 2 has excellent CH₄ conversion rate and CO₂ conversion rate compared to Comparative Example 4 to which the first coating layer is not applied.

As in the above results, it can be confirmed that in the Examples of the present application, the ratio of H₂/CO can be improved compared to the Comparative Examples. Accordingly, it can be confirmed that side reactions caused by the porous metal support are reduced in the Examples of the present application.

Therefore, the catalyst for methane reformation according to an exemplary embodiment of the present application can not only improve adhesion between a porous metal support and a second coating layer comprising a perovskite-based compound represented by Chemical Formula 2, but can also prevent side reactions of the porous metal support by forming a first coating layer comprising the catalyst component-free perovskite-based compound represented by the following Chemical Formula 1.

Furthermore, the catalyst for methane reformation according to an exemplary embodiment of the present application is characterized in that reaction heat is easily controlled compared to pellet-type or powder-type catalysts in the related art because a perovskite-based compound is supported on a porous metal support having high thermal conductivity.

In addition, the catalyst for methane reformation according to an exemplary embodiment of the present application can exhibit high activity even at a high space velocity during a reforming reaction of methane because it is possible to increase the active surface area of the catalyst.

1. A catalyst for methane reformation, comprising:
a porous metal support;
a first coating layer provided on the porous metal support and comprising a perovskite-based compound represented by Chemical Formula 1; and
a second coating layer provided on the first coating layer and comprising a perovskite-based compound represented by Chemical Formula 2:
SrTiO₃ [Chemical Formula 1]
Sr₁₋ₓAₓTi_{α}B_{y}O_{3-δ} [Chemical Formula 2]
wherein, in Chemical Formula 2,
A is selected from Y, Sc, La or lanthanide series elements,
B is Ni, Co, Fe, Mn, Cr, Mo, Ru or Rh,
x is a real number of 0 or more and less than 1,
y is a real number of 0 or more and less than 0.3,
δ is a real number of 0 or more and less than 1,
α is a real number of more than 0.7 and 1 or less, and
(x+y)>0 is satisfied.

2. The catalyst of claim 1, wherein Chemical Formula 2 is represented by Chemical Formula 3 or 4:
SrTi_{α}B_{y}O_{3-δ} [Chemical Formula 3]
Sr₁₋ₓYₓTi_{α}B_{y}O_{3-δ} [Chemical Formula 4]
in Chemical Formulae 3 and 4,
B is Ni or Ru,
x is a real number of more than 0 and less than 1,
y is a real number of more than 0 and less than 0.3, and
δ is a real number of more than 0 and less than 1, and
α is a real number of more than 0.7 and 1 or less.

3. The catalyst of claim 1, wherein the porous metal support is a metal foam comprising NiFeCrAl, NiCrAl, SiC or α-Al₂O₃.

4. The catalyst of claim 1, wherein a content of the perovskite-based compound represented by Chemical Formula 2 is 3 wt % to 40 wt % based on a total weight of the catalyst.

5. The catalyst of claim 1, wherein the catalyst is applied to a steam reforming process, a carbon dioxide (CO₂) reforming process, a catalytic partial oxidation process, an autothermal reforming process, a tri-reforming process or a mixed reforming process.

6. A method for producing a catalyst for methane reformation, the method comprising:
preparing a first solution comprising a precursor of a perovskite-based compound represented by Chemical Formula 1; and a second solution comprising a precursor of a perovskite-based compound represented by Chemical Formula 2;
coating a porous metal support with the first solution, and then performing a first heat treatment process to produce a catalyst precursor coated with a first coating layer; and
coating the catalyst precursor coated with the first coating layer with the second solution, and then performing a second heat treatment process to produce a catalyst coated with a second coating layer:
SrTiO₃ [Chemical Formula 1]
Sr₁₋ₓAₓTi_{α}B_{y}O_{3-δ} [Chemical Formula 2]
wherein, in Chemical Formula 2,
A is selected from Y, Sc, La or lanthanide series elements,
B is Ni, Co, Fe, Mn, Cr, Mo, Ru or Rh,
x is a real number of 0 or more and less than 1,
y is a real number of 0 or more and less than 0.3,
δ is a real number of 0 or more and less than 1,
α is a real number of more than 0.7 and 1 or less, and
(x+y)>0 is satisfied.

7. The method of claim 6, wherein Chemical Formula 2 is represented by Chemical Formula 3 or 4:
SrTi_{α}B_{y}O_{3-δ} [Chemical Formula 3]
Sr₁₋ₓYₓTi_{α}B_{y}O_{3-δ} [Chemical Formula 4]
in Chemical Formulae 3 and 4,
B is Ni or Ru,
x is a real number of more than 0 and less than 1,
y is a real number of more than 0 and less than 0.3, and
δ is a real number of more than 0 and less than 1, and
α is a real number of more than 0.7 and 1 or less.

8. The method of claim 6, wherein the porous metal support is a metal foam comprising NiFeCrAl, NiCrAl, SiC or α-Al₂O₃.

9. The catalyst of claim 1, wherein the porous metal support has a porosity of 10% to 99%.

10. The catalyst of claim 1, wherein the porous metal support has an average pore size (cell size) of 400 μm to 2,000 μm.

11. The catalyst of claim 1, wherein a content of the perovskite-based compound represented by Chemical Formula 1 is 1 wt % to 20 wt %, based on a total weight of the porous metal support.

12. The catalyst of claim 1, wherein a weight ratio of the perovskite-based compound represented by Chemical Formula 1 to the perovskite-based compound represented by Chemical Formula 2 is 1:1 to 1:20.

13. The catalyst of claim 1, wherein the second coating layer is present in a form of protrusions on the first coating layer.

14. The method of claim 6, wherein the first heat treatment process and the second heat treatment process each comprise performing drying and firing.
